(19) United States
(12) Patent Application Publication
(10) Pub. No.: US 2014/0278610 A1
(43) Pub. Date: Sep. 18, 2014

(54) ABUSE TOLERANT TICKETING SYSTEM

(71) Applicant: Live Nation Entertainment, Inc., Beverly Hills, CA (US)

(72) Inventors: John Carnahan, Los Angeles, CA (US); Robert W. McEwen, Los Angeles, CA (US); Vasanth Kumar, Cerritos, CA (US)

(73) Assignee: Live Nation Entertainment, Inc., Beverly Hills, CA (US)

(21) Appl. No.: 14/214,323

(22) Filed: Mar. 14, 2014

Related U.S. Application Data
(60) Provisional application No. 61/788,173, filed on Mar. 15, 2013.

(51) Int. Cl. G06Q 10/02

(52) U.S. Cl. CPC G06Q 10/02
USPC 705/5

(57) ABSTRACT

Interaction pattern associated mapping schemes are used to classify users of ticket distribution system and, more particularly, to provide unique interaction for the users. Different classes and/or scores may be assigned to users based on their interaction and/or profiles. The interface of the ticket distribution system for one or more classes or classes is modified during the purchase process according to the characterization of the user's interaction and other information.

This application claims the benefit of U.S. Provisional Application No. 61/788,173 filed on Mar. 15, 2013, which is hereby incorporated by reference in its entirety for all purposes.

### BACKGROUND

This disclosure relates in general to classifying users of ticket distribution system and, more particularly, but not by way of limitation, to providing unique interaction for the users.

Online ticket purchase web sites are widely used and increasing in popularity. In the world of online ticket purchase, it is not uncommon that tickets are sold out within a certain time after they are being released. Often, ticket brokers like to constantly reserve large block of tickets with good seats to prevent other people from purchasing them, and then resell tickets on a secondary market at an unreasonable price or as a denial of service attempt for online sales while they focus on in-person purchases. Therefore, good seats are unavailable on the primary market or require real ticket buyers to revisit and refresh website periodically. It can be time-intensive and frustrating to the most loyal fans who have to resort to the secondary market to purchase from brokers and scalpers. The ticket purchase websites are often faced with a dilemma, either try to post fewer amount of tickets online and lose revenue, or post all the tickets online and let them fall into ticket brokers' hands.

### SUMMARY

In one embodiment, a system and/or method enables ticket providers to detect improper interaction from users and adapt purchase interface in order to avoid abusive ticket purchase is disclosed. Different classes may be assigned to users based on their interaction profiles. The interface of the ticket distribution system for different users is modified during the purchase process according to user classification and/or score.

In another embodiment, the present invention includes systems and methods for classifying users of ticket distribution system to provide unique interaction for a plurality of users. First interaction is received from a first user of the plurality of users. The first interaction is classified. A first class is assigned to the first user according to the classifying of the first interaction. An interface to the ticket distribution system is operated according to a first profile for the first class. Second interaction from a second user of the plurality of users is received. The second interaction is classified. A second class is assigned to the second user according to the classifying of the second interaction. The interface to the ticket distribution system is modified for the second profile for the second class such that the second user is treated differently from the first user during the purchase process.

In yet another embodiment, the present invention includes systems and methods for classifying users of ticket distribution system to provide unique interaction for a plurality of users. First interaction is received from a first user of the plurality of users. Second interaction is received from a second user of the plurality of users. An interaction classifier model is constructed based on the first interaction from the first user and the second interaction from the second user respectively. The interaction classifier model is applied to third interaction from a third user of the plurality of users. An interaction score corresponding to the third interaction from a third user of the plurality of users is estimated. The interface to the ticket distribution system is modified for the third user during the purchase process.

In various embodiment, the difference in the interface between the first user and the second user includes: checkout speed, responsiveness of the interface, visibility of the interface, ticket cost, ticket quantity availability, ticket seat availability, authentication level, and/or availability of interface.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 depicts a block diagram of an embodiment of a ticket distribution system.

FIG. 2 depicts a block diagram of an embodiment of ticket distribution system.

FIG. 3 illustrates a flowchart of an embodiment of a process for changing the personality of an interface to a ticketing engine according to profiling of a user.

FIG. 4 illustrates a flowchart of an embodiment of a process for configuring interaction patterns from interaction scores, in accordance with certain embodiments of the present disclosure.

FIG. 5 depicts a flowchart of an embodiment of a process for allocating ticket availabilities and allocating seat resources, in accordance with certain embodiments of the present disclosure.

FIG. 6 illustrates a flowchart of an embodiment of a process for changing the personality of an interface with a delay factor to a ticketing engine according to profiling of a user.

FIG. 7 illustrates a method for building an interaction classifyer in accordance with various embodiments of the present invention;

A further understanding of the nature and advantages of various embodiments may be realized by reference to the following figures.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Referring first to FIG. 1, an embodiment of a ticket distribution system 104 is shown interfacing with various users 108, 112, 116, 120. The ticket distribution system 104 controls inventory and payment of users 108, 112, 116, 120 that buy tickets. The users 108, 112, 116, 120 can access the ticket distribution system 104 using mobile apps, web sites, call centers, retail locations, venue box offices, application program interfaces (APIs), etc. There could be in-person users 108 that access a retail location or box office, web users 116 that use a browser as an interface, or app users 112 that use a phone or tablet device.

These users 108, 112, 116, 120 could be retail or wholesale purchasers. The wholesale purchasers could be group purchases or brokers. In some cases, bot users 120 interact with the ticket distribution system 104 to buy tickets. Bot users 120 are typically software, apps or scripts that automatically purchase inventory typically in an abusive way. Various techniques are used to avoid abuse by bot users 120, brokers or group purchasers in favor of the retail purchasers intending to attend the event personally.

Referring next to FIG. 2, an embodiment of a ticket distribution system 104 is shown in detail. A ticketing engine 204 is accessed by users 108, 112, 116, 120 using various interfaces 236 to purchase or sell ticket inventory 224. Users 108, 112, 116, 120 have user accounts 228 that store payment, credentials, demographic information, and audit information. The audit information for each user 108, 112, 116, 120 is stored and used to score each user 108, 112, 116, 120. After some period of time, the audit information may become stale and no longer stored or is weighed less when computing a score for a particular user 108, 112, 116, 120.

From the initial interaction with any interface by a user 108, 112, 116, 120, an interaction classifier 208 automatically observes the interaction between any interface and user 108, 112, 116, 120 to match that interaction with interaction patterns 216. Table I shows examples of interaction patterns 216 and how those interactions are scored. The score for each user is stored in an interaction score database 220. In this embodiment, the score is on a scale of 0-100 or 100-0 but other embodiments could have different scales. For example, an authenticated user after login would have a score of eight if there was prior interaction that caused no concern determined by attempted match to the interaction patterns 216. Matches to multiple interaction patterns 216 could be additive to increase the score and corresponding countermeasures. In this embodiment, the lower the score the more nurturing of users 108, 112, 116, 120 is performed by the interfaces 236 and conversely, the higher the score the more countermeasures are put in place to deter, slow or stop abusive interaction.

TABLE I
Interaction Patterns

| Score | Interaction |
|---|---|
| 8 | Known IP address or range with long good track record |
| 20 | Prior pattern of success with CAPTCHA |
| . . . | . . . |
| 43 | User access from mobile phone app |
| 44 | In-person ticket purchase |
| . . . | . . . |
| 72 | Suspected bot purchaser |
| . . . | . . . |
| 85 | Excessive reserve requests |
| 98 | Known IP address or range with past bad behavior |

In some embodiments, one or more price analytics engines may include logic for implementing pricing features for ticketing engine 204 in various embodiments. By way of example without limitation, the price analytics engine may include logic for one or more aspects of: determining ticket prices; identifying and applying pricing controls/strategies implemented with user profiles and/or interaction patterns; and/or the like.

In some embodiments, a transaction handling engine includes logic for implementing ticket transaction features for ticketing engine 204 in various embodiments. The transaction handling engine includes logic for handling purchase, sale, and transfer transactions. The transaction handling engine applies regulation information specifying business rules and/or interaction scores for controlling transactions. The transaction handling engine handles payment processing relating to transactions.

Some embodiments could modify the score of a user 108, 112, 116, 120 based upon the interface used to interact with the ticketing engine 204. For example, a user from the mobile app could be given a lower initial score because historically the mobile app has less issues with both users 120 or other undesired interaction. Traditionally, the web interface 236 sees more bot users 120 such that interaction coming from that interface 236 would be scored higher initially. With either interface 236, interaction beyond the choice of interface could change the score as more interaction occurs.

The interaction classifier 208 is constantly updating a score for each user, session or originating address. The interaction score 220 is mapped by an interface manipulation engine 240 to one or more interaction profiles 208. Table II shows various interaction profiles triggered by a threshold or range of scores. Some interaction profiles 208 nurture users 108, 112, 116, 120 such as preferred seating or avoiding the need for the user to enter a CAPTCHA, while others thwart, slow or otherwise provide countermeasures to users 108, 112, 116, 120 predicted to be abusive. The interface manipulation engine 240 modifies operation of the interfaces 236 for various users 108, 112, 116, 120. In this way, the interfaces 236 have multiple personalities presented to different users 108, 112, 116, 120. In some embodiments, if more than one interactions performed by one user, an overall interaction score may be calculated by averaging the two or more interaction scores. Other calculation methods may also be used, such as normalization, scaling, or the like.

In the example of Table II, the lowest scored users 108, 112, 116, 120 enjoy preferred seating or avoidance of CAPTCHA entry. For higher scores, the user 108, 112, 116, 120 would have to enter a CAPTCHA to verify that they are a human user 108, 112, 116 and not a bot user 120. For scores above fifty, a delay is introduced during the checkout process. In this embodiment, a delay is inserted after selection of seats, but before they are reserved by the ticketing engine 204. This time delay is scaled according to score and a random or pseudo-random additional delay. At another higher threshold, the interface could become completely or randomly unresponsive during the checkout process by returning a server unavailable or other errors. In some cases, users with interaction score range of 1-49 may be classified as good class users, and users with interaction score range of 50-100 may be classified as bad class users. One or more sub-classes of users is based on interaction score ranges may be assigned to each of the good class and the bad class in one embodiment such that there are many different gradations of users with a like number of different interface experiences as shown in Table II.

TABLE II
Interaction Score

| Score | Interaction Profile |
|---|---|
| 1-10 | Preferred Seating |
| 1-30 | No CAPTCHA |
| 31-50 | CAPTCHA Human Verification |
| 50-65 | 5 second delay plus random factor with CAPTCHA |
| 66-85 | 10 second delay plus random factor with CAPTCHA |
| 86-95 | 15 second delay plus random factor with CAPTCHA |
| | with suboptimal seating |
| 95-100 | 403 Error - Missing Web Page |

With reference to FIG. 3, an embodiment of a process 300 for changing the personality of an interface 236 to a ticketing engine 204 according to profiling of a user 108, 112, 116, 120 is shown. The depicted portion of the process 300 begins in block 304 where a user 108, 112, 116, 120 begins to interact with the interface 236. As the interaction occurs, it is passed to the interaction classifier 208 in block 308. Tracking of a user 108, 112, 116, 120 can be done by IP address, device serial number, MAC address, login, credential, phone number, geolocation, device signature, cookie, or other means. Through interaction with the interaction patterns 216, the interaction classifier 208 is able to score the user 108, 112, 116, 120 in block 312. Various interaction profiles listed in Table II may be selected for user by interaction classifier 208 in block 316. Although the interaction score 220 is shown separately stored, it could be included with the user account information 228. Indeed, all the various information shown as separately stored could be combined or separated in one or more databases or files.

In some embodiments, the interaction classifier 208 may change the interaction score 220 based on interaction history of a user account or an IP address. In some embodiments, based on interaction history from one or more users 108, 112, 116, 120, assumption would be made for the next interaction pattern 216 based on some predetermined interaction score range and/or metrics. The user's interaction history and/or user's purchase history, and other information that may be received from the user 108, 112, 116, 120 or the user's account may be used to generate a category of interaction patterns and interaction modifications specifically tailored to the user. In some embodiments, user interaction and user purchase history may be used to calculate or change characteristics such as delay factor of the interaction modification and/or price of available tickets. The profile characteristics of user may be periodically analyzed to determine trends and/or interaction changes. In some embodiments, a ticket releasing sequence may be determined among different user accounts for a portion of the available tickets (one ten tickets left for an event, for example) based on their interaction score. User 108, 112, 116, 120 with a relatively lower interaction score may be prioritized for purchasing tickets when supply is limited.

The interface manipulation engine 240 uses the interaction score 220 to determine an appropriate interaction profile 208. The interaction profile 208 is applied to the interface 236 to change its personality toward the user 108, 112, 116, 120 in block 320. Should there be no further interaction determined in block 324, processing continues to block 332 where the user completes the purchase of tickets according to the applied interaction profile 208.

Where there is further interaction determined in block 324, a determination is made in block 328 as to whether the current interaction is improper or suspect as possible abusive interaction. If determined to be improper using machine learning techniques, processing goes from block 328 to block 336 where the interaction pattern 216 is stored for detection of similar users. Whether improper or not, as determined in block 328, processing loops back to block 308 where further observation is automatically performed on the user 108, 112, 116, 120. Examples of improper interaction could be an attempt to purchase or to hold or reserve an excessive amount of tickets. In this way, the ticket engine 204 can automatically detect and adapt to bot users 120 or other threats of interest.

In some embodiments, two or more interactions may be detected or monitored for one user 108, 112, 116, 120 throughout one ticket purchase session. By maintaining interaction score within the same class range, a true class may be persistently assigned to the user. For example, by getting interaction scores of 5 and 10 for two interactions, the user may be classified as true good class. In some cases, the interaction monitor and interface manipulation controls may be lifted for good class user to dynamically adjust the usage of processing power where there is very little risk for a user. Adjustment may be made if inconsistent or suspect interaction interaction may be made for one user 108, 112, 116, 120 throughout a ticket purchase session. For example, heavy use of interaction monitoring and interface manipulation is performed on bad class users with inconsistent or suspect interaction.

A number of variations and modifications of the disclosed embodiments can also be used. For example, scoring of interaction could have any number of reactions by the ticket distribution system—from mere annoyances to blacklisting. The thresholds at which a score will generate a different reaction can be programmed differently in different embodiments. Additionally, values of delay, quantity of tickets available, price changes, etc. can be scaled with popularity of an event or sales channel. For example, for an event with heavy traffic can result in more users seeing a delay to slow the distribution of tickets and other techniques to slow bot users 120.

With reference to FIG. 4, an embodiment of a process 400 for matching interaction patterns to interaction scores is shown. The depicted portion of the process begins in block 402, where the interaction classifier 208 receives interaction from a user 108, 112, 116, 120 for assigning an interaction score 404 in block 404. Those interactions may accumulate at a regular rate from one or more users 108, 112, 116, 120. The ticket distribution system 104 periodically gathers the interactions from all users that the ticket distribution system is managing in block 408. There could be screening to focus on higher scored interactions over lower scored interactions. The keywords and other interaction patterns in the interaction profiles are analyzed by the interface manipulation engine 240 in block 412. A mapping is made between interaction pattern of the user to a score such as thoselisted in Table II. That mapping is sent to the ticketing engine 204 by in block 416. In this way, each score range with its interaction pattern(s) is processed by the interface manipulation engine 240 to apply interface modifications.

With reference to FIG. 5, a flowchart of an embodiment of a process for allocating ticket availabilities and seat resources is shown. In block 502, the ticketing engine 204 may allocate and distribute pre-defined section or zone or predefined number of available seats for an event. The tickets are distributed to users 108, 112, 116, 120 through different distribution channels such as auctions, retail businesses, venue ticket offices, kiosks, online stores, and/or the like. In block 504, an interaction is received when a user 108, 112, 116, 120 begins to engage with the interface 236. Through interaction with the interaction patterns 216, the interaction classifier 208 is able to score the user interaction in block 506. In block 508, a mapping is made to interaction pattern that is related to one or more interaction profiles listed in Table II. Various manipulating factors to control seat resource, interface throttling techniques, and/or quantity of available tickets may be identified by interface manipulation engine 240 in step 510. An updated seat resource and/or an updated available quantity of tickets may be issued to the user 108, 112, 116, 120 in block 512. For example, availability of tickets inventory may represent fewer available tickets for an unknown or low scoring user (100 available tickets with only 10 shown on the website, for example). The number of available tickets may be decreased by half if a high interaction score is determined in block 512. Other embodiments could make fewer seats or zones available in the seat map and/or modify the interface to slow its operation, appear broken or stalled.

With reference to FIG. 6, a flowchart of an embodiment of a process for changing the personality of an interface with a delay factor to a ticketing engine 204 is shown. As the interaction occurs, it is passed to the interaction classifier 208 in block 308. Further interaction may be determined in block 616, a determination is made based on the user classification with predetermined interaction score range as to whether the current delay interaction is improper or suspect as possible abusive interaction.

Some embodiments can tolerate different amounts of abusive behavior in favor of selling more tickets or selling them more quickly. For example, thresholds can be raised, abusive interaction patterns ignored, scores scaled, delays reduced or eliminated, and/or application of interaction profiles reduced. These techniques could open the ticket distribution system 104 to selling tickets at a faster velocity with more risk of abuse. Other interaction patterns that slow ticket purchases, such as excessive use of reserves could still be used while being more permissive to activity that increases sales. The tolerance of abusive behavior could be scaled up or down during the on sales window prior to an event. For example, heavy control of abuse could be in place until two days before the event to allow lifting of controls that would discourage brokers and group purchases.

In some embodiments, the thresholds at which a score will generate a different reaction can be programmed. Additionally, values of delay, quantity of tickets available, price changes, etc. can be scaled with popularity of an event or sales channel. One or more delay pattern may be selected to manipulate interfaces 236 besides the CAPTCHA in block 620. For example, number of ticket purchase submission may be monitored for a certain IP address, webpage cookies may be changed via JavaScript or time stamped in the case of alternating or random IP addresses, a hidden link may be provided for tracking interface entry from bot users, a pop-up window may be provided with input requirement (such as a token, a math test, a IQ test, trivia question, etc.), and/or the like. By applying one or more delay patterns, alone or in combination, a ticket purchase submission may be paused for further delay evaluation in block 624 or rejected. Whether improper or not, as determined in block 328, processing loops back to block 308 where further observation is automatically performed on the user 108, 112, 116, 120. An example of improper delay interaction could be an attempt to purchase or to hold or reserve an excessive amount of tickets. Interaction scores may be simplified into three classes or ranges: a good class (yes to block 616), a bad class (yes to block 624) and a maybe class (no to block 624 that may require further evaluation) in one embodiment.

With reference to FIG. 7, an embodiment of a method 700 for configuring an interaction classifier 208 is shown. The scores for different machine detectable patterns can be manually weighted or performed with machine learning to update the ability of the ticketing engine 204 to react to abusive behavior through thwarting mechanisms in the interface. The depicted portion of the process begins in block 702 where actual interaction is recorded that the designer determines is abusive. Historical interaction or theorized interaction could be used as a model. Those patters are assigned a score or increase to the cumulative score in block 704. The range of cumulative scores is divided into ranges with thresholds in block 708. Changes to the interface that thwart abuse or ticket purchase are assigned in block 712. The thwarting mechanisms can be cumulatively assigned or changed for each threshold crossed. For example, score range 50-60 could use thwarting mechanisms A, C, D, E and score range 60-65 could use B, D, E, F, H. In block 716, the thwarting model is loaded into the production engine 204. Other embodiments could monitor for interaction patterns determined suspicious and automatically select the thwarting mechanisms automatically found to be most effective.

In some embodiments, a mapping for each interaction pattern may be built based on interaction history for one or more users. Mapping for a new interaction pattern may be performed by matching the website log, website entry, and/or other mapping metrics to the mapping training data for each recorded or theorized interaction. Any system or method for constructing the set of interaction patterns is within the scope of the present invention. In some cases, interaction profile listed in Table 1 may be treated as known variables for an interaction classifier model. If unknown variable from new interaction is detected, a notice or a flag message may be sent to the ticket engine 204 and wait for further interaction. While waiting, a presumed interaction score may be generated for the user as a cautionary measure. New interactions would be added to the interaction pattern database.

In some embodiments, interaction score 220 together with a probability factor, alone or in combination, may be generated in order to manipulate the interfaces 236 of the user 108, 112, 116, 120. For example, for interaction with an interaction score of 45 and a probability of 0.9 (or 90%) of being a bot or abusive user, the interface modification may be same to the users with interaction score of 70. In some embodiments, two classes (good class and bad class, for example) and/or multi-class machine learning techniques (support vector machine, for example) may be used to store two or more classes of the interaction pattern 216 for detection of similar users.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1-14. (canceled)

15. A ticket distribution system for classifying users and provide unique interaction for a plurality of users, the ticket distribution system comprising:
a ticketing engine that:
receives a first interaction, wherein a first user is part of the plurality of users;
receives a second interaction, wherein a second user is part of the plurality of users;
correlates the first interaction of the first user with the ticket distribution system;
correlates the second interaction of the second user with the ticket distribution system;
an interaction classifier that:
classifies the first interaction of the first user with the ticket distribution system;
assigns a first class to the first user according to the classification of the first interaction;
operates an interface to the ticket distribution system according to a first profile for the first class;
classifies the second interaction of the second user with the ticket distribution system;
assigns a second class to the second user according to the classification of the second interaction; and
an interface manipulation engine that:
modifies the interface to the ticket distribution system for a second profile for the second class such that the second user is treated with a range of different interface factors from the first user during the purchase process;
wherein the different interface factor between the first user and the second user is chosen from a group consisting of:
checkout speed;
responsiveness of the interface;
visibility of the interface;
ticket cost;
ticket quantity availability;
ticket seat availability;
authentication level; and
availability of the interface.

16. The ticket distribution system as recited in claim 15, wherein the interaction classifier and the interface manipulation engine are further configured to:
map the first profile for the first class to the first user to a first interaction score;
map the second profile for the second class to a second interaction scores, wherein the second interaction score is different than the first interaction score; and
modify the interface to the ticket distribution system of the second user based on the first interaction score and the second interaction score.

17. The ticket distribution system as recited in claim 16, wherein modifying the interface to the ticket distribution system for the second user upon triggering by the second interaction score falling within a range of interaction scores.

18. The ticket distribution system as recited in claim 16, wherein the interaction classifier and the interface manipulation engine are further configured to update the first interaction score and the second interaction score periodically based on further interactions of the first user of the plurality of users and further interactions of the second user of the plurality of users.

19. The ticket distribution system as recited in claim 15, wherein the checkout speed of the ticket distribution system further comprises applying interface factors for the first user and the second user is chosen from a group consisting of: hidden link entry, pop-up field entry, CAPTCHA entry, IQ question entry, math question entry, and token entry.

20. A method for classifying users of a ticket distribution system to provide unique interaction for a plurality of users, comprising:
receiving a first interaction, wherein a first user is part of the plurality of users;
correlating the first interaction of the first user with the ticket distribution system;
classifying the first interaction of the first user with the ticket distribution system;
assigning a first class to the first user according to the classifying of the first interaction;
operating an interface to the ticket distribution system according to a first profile for the first class;
receiving a second interaction, wherein a second user is part of the plurality of users;
correlating the second interaction of the second user with the ticket distribution system;
classifying the second interaction of the second user with the ticket distribution system;
assigning a second class to the second user according to the classifying of the second interaction; and
modifying the interface to the ticket distribution system for a second profile for the second class such that the second user is treated with a different interface factor than the first user during the purchase process;
wherein the different interface factor between the first user and the second user is chosen from a group consisting of:
checkout speed;
responsiveness of the interface;
visibility of the interface;
ticket cost;
ticket quantity availability;
ticket seat availability;
authentication level; and
availability of the interface.

21. The method for classifying users of the ticket distribution system to provide unique interaction for a plurality of users as recited in claim 20, further comprising:
mapping the first profile for the first class to the first user to a first interaction score;
mapping the second profile for the second class to a second interaction scores, wherein the second interaction score is different than the first interaction score; and
modifying the interface to the ticket distribution system of the second user based on the first score and the second interaction score.

22. The method for classifying users of the ticket distribution system to provide unique interaction for a plurality of users as recited in claim 21, wherein modifying the interface to the ticket distribution system for the second user upon triggering by the second interaction score falling within a range of interaction scores.

23. The method for classifying users of the ticket distribution system to provide unique interaction for a plurality of users as recited in claim 21, further comprising updating the first interaction score and the second interaction score periodically based on further interactions of the first user of the plurality of users and further interactions of the second user of the plurality of users.

24. The method for classifying users of the ticket distribution system to provide unique interaction for a plurality of users as recited in claim 20, wherein the checkout speed of the ticket distribution system further comprises applying interface factors for the first user and the second user chosen from a group consisting of: hidden link entry, pop-up field entry, CAPTCHA entry, IQ question entry, math question entry, and token entry.

25. A ticket distribution system for classifying users and provide unique interaction for a plurality of users, the ticket distribution system comprising:
one or more processors; and
one or more memories coupled with the one or more processors, wherein the one or more processors and the one or more memories are configured to:
receive a first interaction, wherein a first user is part of the plurality of users;
correlate the first interaction of the first user with the ticket distribution system;
classify the first interaction of the first user with the ticket distribution system;
assign a first class to the first user according to the classification of the first interaction;
operate an interface to the ticket distribution system according to a first profile for the first class;
receive a second interaction, wherein a second user is part of the plurality of users;
correlate the second interaction of the second user with the ticket distribution system;
classify the second interaction of the second user with the ticket distribution system;
assign a second class to the second user according to the classification of the second interaction; and
modify the interface to the ticket distribution system for a second profile for the second class such that the second user is treated with a range of different interface factors from the first user during the purchase process;
wherein the different interface factor between the first user and the second user is chosen from a group consisting of:
checkout speed;
responsiveness of the interface;
visibility of the interface;
ticket cost;
ticket quantity availability;
ticket seat availability;
authentication level; and
availability of the interface.

26. The ticket distribution system as recited in claim 25, wherein the one or more processors and one or more memories are further configured to:
map the first profile for the first class to the first user to a first interaction score;
map the second profile for the second class to a second interaction scores, wherein the second interaction score is different than the first interaction score; and
modify the interface to the ticket distribution system of the second user based on the first interaction score and the second interaction score.

27. The ticket distribution system as recited in claim 26, wherein modifying the interface to the ticket distribution system for the second user upon triggering by the second interaction score falling within a range of interaction scores.

28. The ticket distribution system as recited in claim 26, wherein the one or more processors and one or more memories are further configured to update the first interaction score and the second interaction score periodically based on further interactions of the first user of the plurality of users and further interactions of the second user of the plurality of users.

29. The ticket distribution system as recited in claim 25, wherein the checkout speed of the ticket distribution system further comprises applying interface factors for the first user and the second user chosen from a group consisting of: hidden link entry, pop-up field entry, CAPTCHA entry, IQ question entry, math question entry, and token entry.
